(19) United States
(12) Patent Application Publication
(10) Pub. No.: US 2002/0154160 A1
(43) Pub. Date: Oct. 24, 2002

(54) Information providing system, program, information storage medium, and user interface setting method

(75) Inventor: Matsuhisa Hosokawa, Hino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/099,967

(22) Filed: Mar. 19, 2002

(30) Foreign Application Priority Data
Mar. 22, 2001 (JP) 2001-082360

(51) Int. Cl. G09G 5/00

(52) U.S. Cl. 345/738; 345/733

(57) ABSTRACT

The invention provides an information providing system that is capable of providing information that is appropriate for attributes of a terminal device, a program, an information storage medium, and a user interface setting method. An information providing device that provides operation information to a portable phone is provided with a printer operation program group, containing a plurality of types of printer operation programs, and a selection section that selects a program on the basis of attribute information from the portable phone.

### BACKGROUND OF THE INVENTION

1. Field of Invention

The present invention relates to an information providing system, a program, an information storage medium, and a user interface setting method.

2. Description of Related Art

An information providing system for distributing information of a browser to be used, and information that is appropriate for attributes, such as the age of a user, to a terminal device which is operated by the user have been proposed (for example, Japanese Unexamined Patent Application Publication No. 11-272574).

This publication discloses ascertaining attributes, such as the age of a user, by using a personal identification card. However, this publication does not disclose how to ascertain a browser used in a terminal device, as well as the attributes of a terminal device itself, such as the image display performance.

The attributes of the terminal device itself include a plurality of attributes, such as image display performance and audio output performance. All of these attributes are not taken into consideration equally, and in practice, importance differs depending on the attribute.

When the user cannot operate a printer or similar device with a user interface that is appropriate for the attributes of a terminal device to be used, cases may exist in which it is difficult to view the screen, or the operation may take a lot of time.

### SUMMARY OF THE INVENTION

The present invention addresses the above-described problems, and provides an information providing system which is capable of providing information that is appropriate for attributes of a terminal device, a program, an information storage medium, and a user interface setting method.

In order to address the above-described problems, the information providing system of the present invention provides operation information to perform a predetermined operation in a predetermined terminal device. The information providing system includes:

an acquiring device that acquires attribute information indicating attributes of a terminal device;

a selection device that selects, based on the acquired attribute information, operation information that is appropriate for the terminal device from a plurality of types of operation information stored in a predetermined storage area; and

a providing device that provides the selected operation information to the terminal device.

The attribute information indicates a plurality of attributes, and a priority is set for each attribute, and the selection device selects the operation information on the basis of the priority.

The present invention also provides a computer-usable program for use with an information providing system to provide operation information to perform a predetermined operation in a predetermined terminal device. The program includes:

an acquiring program for acquiring attribute information indicating attributes of the terminal device;

a selection program for selecting, based on the acquired attribute information, operation information appropriate for the terminal device from a plurality of types of operation information stored in a predetermined storage area; and

a providing program for providing the selected operation information to the terminal device. The attribute information indicates a plurality of attributes, and a priority is set for each attribute. The selection program selects the operation information on the basis of the priority.

The present invention also provides a computer-usable information storage medium that stores the above-described program.

The present invention also provides a user interface setting method to set a user interface in a predetermined terminal device. The user interface setting method includes:

acquiring attribute information indicating a plurality of attributes of the terminal device in order to set the user interface;

selecting, based on the acquired attribute information, setting information appropriate for the terminal device from a plurality of types of setting information of a plurality of types of user interfaces; and

providing the selected setting information to the terminal device. The attribute information indicates a plurality of attributes, and a priority is set for each attribute. The selection step selects the setting information on the basis of the priority.

According to the present invention, as a result of selecting operation information or setting information based on a priority, operation information, which is more appropriate for the attributes of the terminal device, etc., can be provided.

Furthermore, in this manner, as a result of providing a priority, the volume of traffic, such as operation information, etc., can be reduced.

More specifically, for example, when the priority of an image display is higher than that of audio output, as a result of providing a program for image display and not providing a program for audio output, the amount of data transmission and the amount of data stored in the terminal device can be reduced in comparison with a case in which both programs for image display and for audio output are provided.

Here, examples of the attributes of the terminal device include the category (portable phone, PDA, PC, etc.), the model, the presence or absence of a display function, the resolution, capability/incapability of color display, capability/incapability of audio output, the type of font, the type of input device (button, microphone, etc.), and the language.

In the information providing system, the program, and the information storage medium, the providing device/program may provide, to the terminal device, priority setting information to prompt a user of the terminal device to set a priority for each attribute.

In the setting method, the providing step may provide, to the terminal device, priority setting information to prompt a user of the terminal device to set a priority for each attribute.

According to this structure/operation, since the user can set a priority by himself/herself, an operation corresponding to his/her preference can be performed.

Furthermore, in the information providing system, the program, and the information storage medium, the acquiring device/program may only acquire attribute information indicating the attribute having a high priority from the terminal device.

Furthermore, in the acquiring step, only attribute information indicating the attribute having a high priority may be acquired from the terminal device.

According to this structure/operation, as a result of only acquiring attribute information indicating the attribute having a high priority, the acquiring of attribute information can be performed more quickly.

### BRIEF DESCRIPTION OF THE DRAWINGS

FIG. 1 is a block diagram showing functional blocks of a portable phone and an information providing device according to one embodiment of the invention;

FIG. 2 is a chart showing the data structure of an attribute data group according to one embodiment of the invention;

FIG. 3 is a chart showing the data structure of a printer operation UI program group according to one embodiment of the invention; and

FIG. 4 is a flowchart showing the processes from when attribute information is acquired to when a UI program is transmitted according to one embodiment of the invention.

### DETAILED DESCRIPTION OF PREFERRED EMBODIMENTS

The present invention will be described below with reference to the drawings by taking, as an example, a case in which a printer is operated by using a portable phone, which is one type of terminal device.

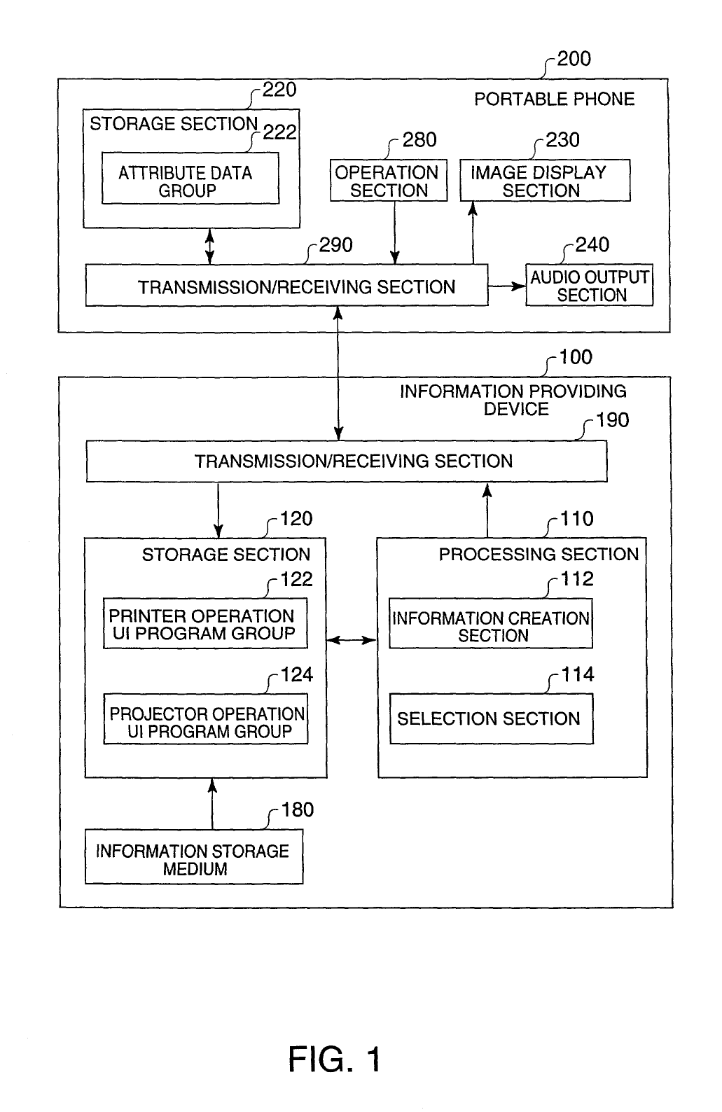

FIG. 1 is a block diagram showing functional blocks of a portable phone 200 and an information providing device 100 according to one embodiment of the invention.

For example, when information is provided from the same information providing device 100 to a terminal device, and a printer is operated from the terminal device, the provided operation information of the printer must be changed according to the image display performance and presence or absence of the audio output function of the terminal device.

For example, when the resolution is low as in the portable phone 200, it is necessary to provide operation information for a simplified image display, in comparison with a terminal device capable of displaying an image at a high resolution, such as for a PC (Personal Computer).

An image which is used when a user operates in this manner is called a user interface (hereinafter referred to as a “UI”).

In this embodiment, operation information, which is provided according to the attributes of the terminal device, such as the portable phone 200, is changed.

Furthermore, in this embodiment, operation information, which is provided according to the priority of a plurality of attributes of the terminal device, is changed.

Here, the functional blocks of the portable phone 200 and the information providing device 100 will be described.

The portable phone 200 includes a storage section 220 that stores an attribute data group 222 indicating a plurality of attributes (for example, the resolution, the presence or absence of a color display function, the presence or absence of an audio output function, etc.) of the portable phone 200, an operation section 280 for a user to perform operations, a transmission/receiving section 290 that transmits operation information to the information providing device 100 and that receives the operation information from the information providing device 100, an image display section 230 that displays a UI image on the basis of the received operation information, and an audio output section 240 that outputs UI audio on the basis of the received operation information.

Meanwhile, the information providing device 100 includes a transmission/receiving section 190 that receives (acquiring) operation information and transmits (provides) the operation information to the portable phone 200, a storage section 120 that stores a plurality of types of operation information, and a processing section 110 that selects operation information on the basis of the attribute information contained in the operation information.

The storage section 120 has stored therein, as a plurality of types of operation information, a printer operation UI program group 122, which is printer operation information, and a projector operation UI program group 124, which is projector operation information.

The printer operation UI program group 122 and the projector operation UI program group 124 are provided with a plurality of types of UI programs according to the operation target and the attributes.

The processing section 110 includes a selection circuit 114 that selects a UI program compatible with the portable phone 200 on the basis of attribute information, and an information creation section 112 that creates operation information for the portable phone 200 on the basis of the selected UI program.

As for specific hardware which realizes these sections, for example, a router can be used for the transmission/receiving sections 190 and 290, for example; a RAM can be used for the storage sections 120 and 220, for example; a CPU can be used for the processing section 110, for example; an operation button can be used for the operation section 280, for example; a liquid-crystal display device can be used for the image display section 230, for example; and a speaker can be used for the audio output section 240, for example.

Either circuits may be used in a hardware manner, or programs may be used in a software manner, to achieve these sections.

For example, a program for realizing the function of the selection circuit 114, etc., may be read from the information storage medium 180 in order to realize the above-described functions.

A CD-ROM, DVD-ROM, ROM, RAM, HDD, etc., may be used for the information storage medium 180, for example. The method of reading the information therefrom may be a contact method or a non-contact method.

Instead of the information storage medium 180, each of the above-described functions can also be realized by downloading a program for realizing each of the above-described functions from a host apparatus, etc., via a transmission line. That is, the program for realizing each of the above-described functions may be realized in a carrier wave.

Here, the data structure of the attribute data group 222 and the printer operation UI program group 122 will be described.

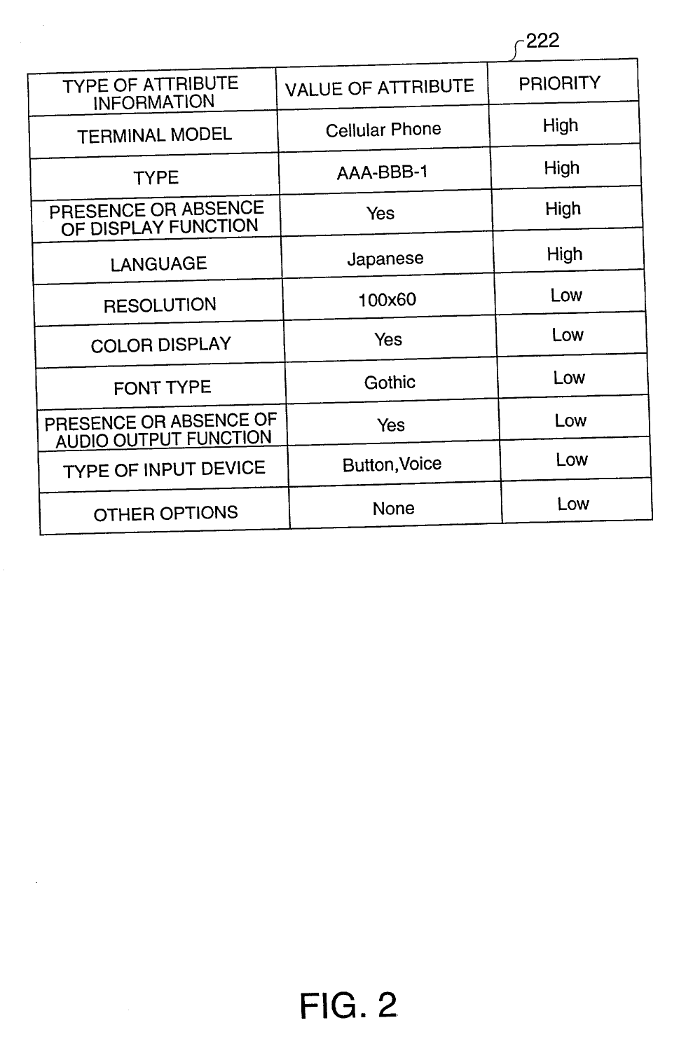

FIG. 2 is a chart that shows the data structure of the attribute data group 222 according to one embodiment of the invention.

The attribute data group 222 is a data set indicating the attributes of the portable phone 200. Examples of the items of the attribute data group 222 include “type of attribute information”, “value of the attribute”, and “priority”.

More specifically, for example, the case where “type of attribute information” is “terminal model”, “value of the attribute” is “Cellular Phone”, and “priority” is “high”, shows that the terminal device is a portable phone 200.

Furthermore, for example, the case where “type of attribute information” is “presence or absence of audio output function”, “value of the attribute” is “Yes”, and “priority” is “low”, shows that the terminal device has an audio output function.

Furthermore, if “priority” is “high”, this indicates that the priority is high, and if “priority” is “low”, this indicates that the priority is low. The “priority” is set for each attribute, such as “terminal model”. The information providing device 100 provides operation information to the portable phone 200 by placing importance to an attribute having a high priority.

The “priority” is not limited to binary values of “high” and “low”, and can also be set to multiple levels using numeric values of “1”, “2”, “3”, etc.

Next, the data structure of the printer operation UI program group 122 will be described.

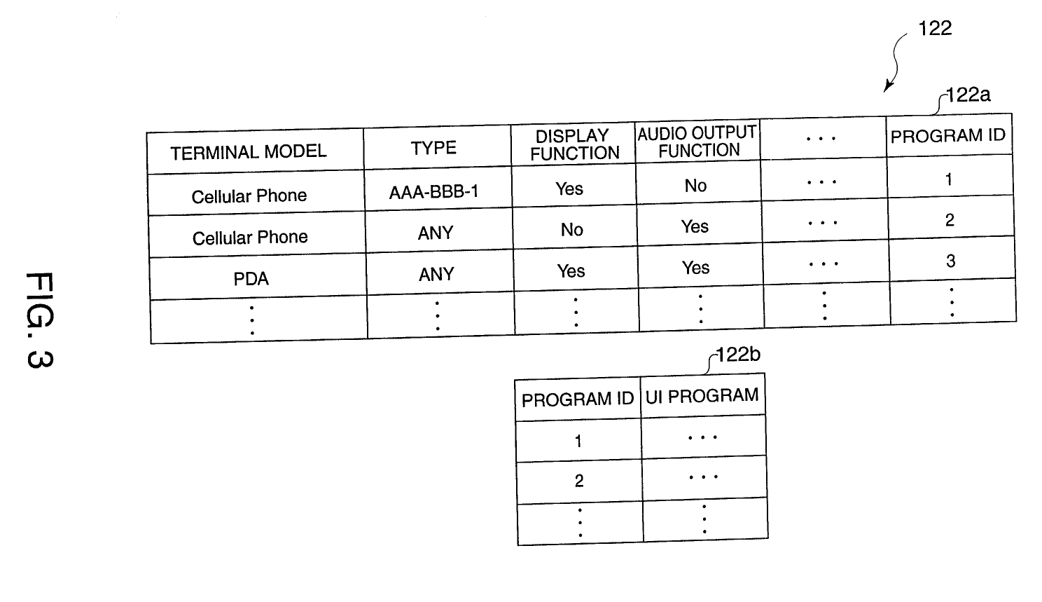

FIG. 3 is a chart that shows the data structure of the printer operation UI program group 122 according to one embodiment of the invention.

The printer operation UI program group 122 contains related data 122a to relate attributes with a UI program, and a UI program group 122b.

Examples of the items of the related data 122a include items indicating the attributes of the terminal device, such as “terminal model”, “type”, “display function”, and “audio output function”, and “program ID” to identify a UI program.

The UI program group 122b is formed of a plurality of “program IDs” and the “programs” identified by the corresponding “program IDs”.

For example, in a case where the “terminal model” is “Cellular Phone”, the “type” is “AAA-BBB-1”, the “display function” is “Yes”, and the “audio output function” is “No”, the “program ID” is “1”, and the selection section 114 selects a UI program whose “program ID” is “1”. The data structure of the projector operation UI program group 124 is also the same as the data structure of the printer operation UI program group 122.

Next, the processes using each of the above-described sections is described.

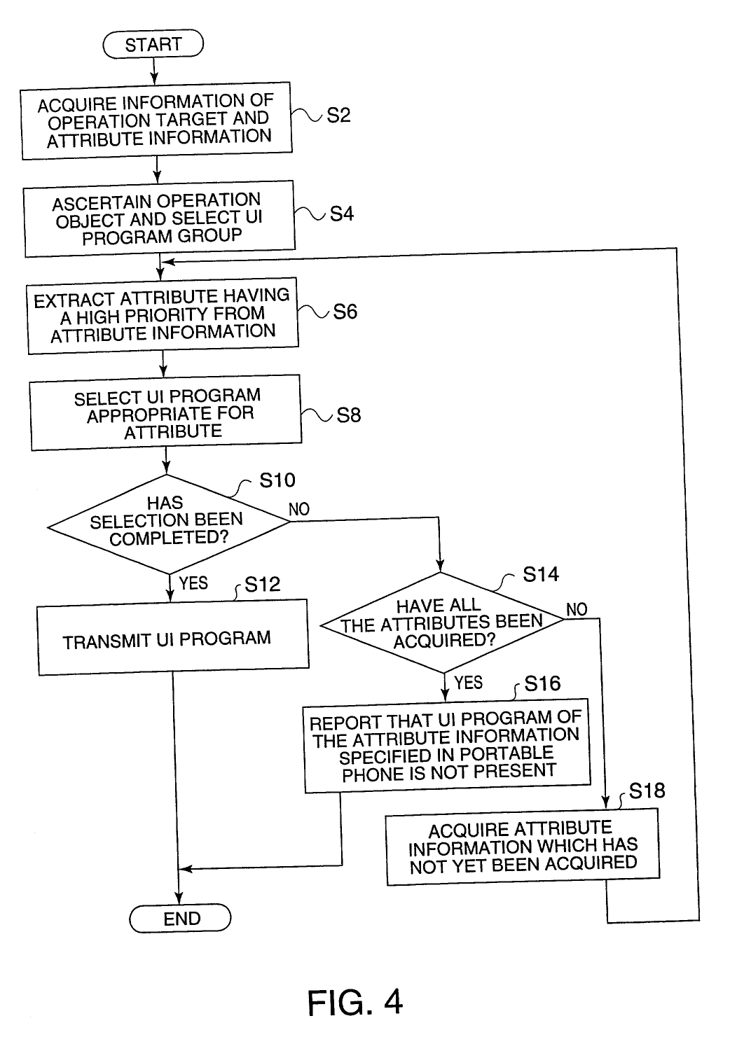

FIG. 4 is a flowchart showing the processes from when attribute information is acquired to when a UI program is transmitted according to one embodiment of the invention.

For example, in a case where a user requests, using the operation section 280, to perform a printer operation using the portable phone 200, the transmission/receiving section 290 creates operation information on the basis of the request information and the attribute data group 222, and transmits the operation information to the information providing device 100.

The transmission/receiving section 190 acquires the information of an operation target (a printer in this embodiment), and the operation information containing attribute information (step S2).

The selection circuit 114 ascertains the operation target on the basis of the information of the operation target, acquired by the transmission/receiving section 190, and selects the UI program group of the corresponding operation target (step S4). In this embodiment, the selection circuit 114 selects the printer operation UI program group 122.

Furthermore, the selection circuit 114 extracts information having a high priority, that is, attribute information whose “priority” is “high”, from the attribute information acquired by the transmission/receiving section 190 (step S6).

Then, the selection section 114 selects a UI program that is appropriate for the attribute from the printer operation UI program group 122 on the basis of the attribute information whose “priority” is “high” (step S8).

For example, in a case where the “terminal model” is “Cellular Phone”, the “type” is “AAA-BBB-1”, the “display function” is “Yes”, and the “audio output function” is “No”, the “program ID” is “1”, and the selection section 114 selects a UI program whose “program ID” is “1” (step S10).

When the selection has been completed by the selection section 114 by referring to all of the attributes on the basis of the attribute information (step S10), the information creation section 112 creates operation information containing all of the selected UI programs.

Then, the transmission/receiving section 190 transmits the created operation information (containing the selected UI program) to the portable phone 200 (step S12).

When the selection has not been completed (step S10), the selection section 114 determines whether or not all of the attributes could be acquired (step S14).

When it is determined that all of the attributes can be acquired by the selection circuit 114, regardless of the fact that selection has not been completed (step S14), the transmission/receiving section 190 reports to the portable phone 200 that there is no UI program that is appropriate for the specified attribute information (step S16).

Where it is determined that not all of the attributes can be acquired by the selection circuit 114 (step S14), the transmission/receiving section 190 requests that the portable phone 200 transmit attribute information which has not yet been acquired, and acquires the attribute information from the portable phone 200 (step S18).

After the attribute information is acquired (step S18), the information providing device 100 performs the processes of step S6 to step S18 repeatedly.

In the above-described manner, operation information containing the attributes of the portable phone 200 and the UI program that is appropriate for the operation target specified by the user is transmitted to the portable phone 200 by the information providing device 100.

As a result, the portable phone 200 displays a UI image for printer operation on the basis of the UI program contained in the operation information, and the user operates the printer in a state in which the UI image is displayed.

In the manner described above, according to this embodiment, as a result of selecting the setting information on the basis of a priority, it is possible to provide setting information which is more appropriate for the attributes of a terminal device.

Furthermore, as a result of providing a priority in this manner, if only information having a high priority is transmitted/received, it is possible to reduce the amount of data of operation information and setting information which are transmitted/received.

The present invention is not limited to the above-described embodiments, and the present invention can also be applied to various modifications.

For example, the terminal device is not limited to the portable phone 200, and various terminal devices, such as a PDA (Personal Digital Assistant) or a PC (Personal Computer), can be used.

Rather than being a single device as the information providing device 100 discussed above, the functions of the selection section 114, the storage section 120, etc., can be distributed among a plurality of devices in order to realize this embodiment. For example, the following construction may be adopted: in a case where a UI program is distributed among a plurality of devices, and the UI program appropriate for the attributes is not present in a particular device, an inquiry can be made to another device as to whether it has the applicable UI program. If the UI program is present in that device, the UI program is obtained from that device.

Furthermore, for the attribute information transmitted from the portable phone 200 to the information providing device 100, all of the attribute information possessed by the portable phone 200 may be transmitted, or only the attribute information having a high priority may be transmitted.

When only the attribute information having a high priority is transmitted, since the amount of data is reduced, the transmission/reception of attribute information can be performed at a higher speed.

As shown in steps S14 and S18 of FIG. 4, by requesting that the portable phone 200 only transmit attribute information indicating necessary information when necessary, unnecessary traffic can be reduced.

The operation targets by the terminal device are not limited to a printer and a projector, and examples thereof include various devices, such as a scanner and a household electrical appliance, for example.

Furthermore, the setting of a priority may be specified by the user.

For example, the information creation section 112 may be formed so as to create priority setting information to set a priority in the portable phone 200, and the priority setting information may be transmitted to the portable phone 200 by using the transmission/receiving section 190.

As a result, the portable phone 200 may display an image to set a priority on the basis of the priority setting information by using the image display section 230.

According to this structure/function, it is possible for the user to set a priority corresponding to one's preference. As a result, since the set priority is incorporated in the UI, it is possible for the user to perform an operation more easily.

Furthermore, the operation information which is provided by the information providing device 100 to a terminal device, such as the portable phone 200, is not limited to information to operate an operation target, such as a printer, and the operation information may be information to perform a predetermined operation to set internal information of a terminal device.

Rather than a UI program being stored in the storage section 120, operation information containing the UI program may be directly stored. As a result, the information creation section 112 becomes unnecessary, and the selection section 114 selects operation information.

With such an arrangement, it is also possible for the information providing device 100 to provide operation information which is appropriate for the attributes of the terminal device.

What is claimed is:

1. An information providing system that provides operation information to perform a predetermined operation in a predetermined terminal device, said information providing system comprising:
an acquiring device that acquires attribute information indicating attributes of said terminal device;
a selection device that selects, based on the acquired attribute information, operation information that is appropriate for said terminal device from a plurality of types of operation information stored in a predetermined storage area; and
a providing device that provides the selected operation information to said terminal device,
said attribute information indicating a plurality of attributes, a priority being set for each attribute, and said selection device selecting said operation information on the basis of said priority.

2. The information providing system according to claim 1, said providing device providing, to said terminal device, priority setting information to prompt a user of said terminal device to set the priority for each attribute.

3. The information providing system according to claim 1, said acquiring device acquiring only the attribute information that indicates said attribute having a high priority from said terminal device.

4. A computer-usable program for use with an information providing system that provides operation information to perform a predetermined operation in a predetermined terminal device, said program implementable by a computer and comprising:
an acquiring program for acquiring attribute information indicating attributes of said terminal device;
a selection program for selecting, based on the acquired attribute information, operation information that is appropriate for said terminal device from a plurality of types of operation information stored in a predetermined storage area; and
a providing program for providing the selected operation information to said terminal device,
said attribute information indicating a plurality of attributes, a priority being set for each attribute, and said selection program selecting said operation information on the basis of said priority.

5. The program according to claim 4, said providing program providing, to said terminal device, priority setting information to prompt a user of said terminal device to set a priority for each attribute.

6. The program according to claim 4, said acquiring program acquiring only the attribute information indicating said attribute having a high priority from said terminal device.

7. A computer-usable information storage medium, comprising:
the program according to claim 4 stored therein.

8. A user interface setting method that sets a user interface in a predetermined terminal device, said user interface setting method comprising:
acquiring attribute information indicating a plurality of attributes of said terminal device in order to set said user interface;
selecting, based on the acquired attribute information, setting information that is appropriate for said terminal device from a plurality of types of setting information of a plurality of types of user interfaces; and
providing the selected setting information to said terminal device,
said attribute information indicating a plurality of attributes, a priority being set for each attribute, and said selection step selecting said setting information on the basis of said priority.

9. The user interface setting method according to claim 8, said providing step providing, to said terminal device, priority setting information to prompt a user of said terminal device to set a priority for each attribute.

10. The interface setting method according to claim 8, said acquiring step acquiring only the attribute information indicating said attribute having a high priority from said terminal device.
